(19) United States
(12) Patent Application Publication
(10) Pub. No.: US 2026/0311519 A1
(43) Pub. Date: Oct. 8, 2026

(54) SYSTEMS AND METHODS FOR OPTIMIZING VEHILCE PERFORMANCE BASED ON AERODYNAMIC PROFILE

(71) Applicant: Ford Global Technologies, LLC, Dearborn, MI (US)

(72) Inventors: Keith Weston, Canton, MI (US); Andrew Brady Brown, Royal Oak, MI (US); John Robert Van Wiemeersch, Novi, MI (US); Todd Ansbacher, Westland, MI (US); Brendan Diamond, Naples, FL (US); Stuart C. Salter, White Lake, MI (US)

(73) Assignee: Ford Global Technologies, LLC, Dearborn, MI (US)

(21) Appl. No.: 19/098,702

(22) Filed: Apr. 2, 2025

(51) Int. Cl. G07C 5/00; G01C 21/36; G06F 3/0486; G06F 3/04883; G06F 3/16

(52) U.S. Cl. CPC G07C 5/004; G01C 21/3691; G06F 3/0486; G06F 3/04883; G06F 3/167

(57) ABSTRACT

A vehicle including a processor and a memory for storing instructions is disclosed. The processor may obtain user inputs associated with a load connected to a vehicle and estimate an aerodynamic profile of the vehicle with the load based on the user inputs. The processor may further calculate an estimated range or a change in a driving efficiency for the vehicle based on the aerodynamic profile and perform a predetermined action responsive to calculating the estimated range.

### FIELD

The present disclosure relates to vehicles and more specifically to systems and methods for optimizing vehicle performance based on an aerodynamic profile of a vehicle with an external load connected to or placed on the vehicle.

### BACKGROUND

Internal Combustion Engine (ICE) vehicles and Battery Electric Vehicles (BEVs) experience reduced range when carrying external loads (e.g., trailers, bicycles, etc.). Such external loads increase drag and resistance, which makes the vehicle work harder to move. For instance, when an external load (e.g., a bicycle) is positioned on a vehicle top portion, the airflow may disrupt, resulting in greater air resistance when the vehicle moves forward. Similarly, when an external load (e.g., a trailer) is attached to a vehicle rear portion, the trailer may extend the vehicle profile, adding to the drag and the resistance. In the case of a BEV, a battery range may be reduced due to this drag and resistance, and in the case of an ICE vehicle, the fuel consumption may increase. It is desirable to optimize the range when the vehicle carries external load(s).

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a first example scenario of obtaining user inputs associated with a load attached to a vehicle, in accordance with the present disclosure.

FIG. 3 depicts a second example scenario of obtaining user inputs associated with a load attached to a vehicle, in accordance with the present disclosure.

FIG. 4 depicts a third example scenario of obtaining user inputs associated with a load attached to a vehicle, in accordance with the present disclosure.

FIG. 5 depicts a fourth example scenario of obtaining user inputs associated with a load attached to a vehicle, in accordance with the present disclosure.

FIG. 6 depicts a flow diagram of an example method to optimize vehicle movement in accordance with the present disclosure.

### DETAILED DESCRIPTION

### Overview

The present disclosure describes a system and method to optimize vehicle performance when a vehicle may be loaded with an external load. The load may be, for example, a trailer, a bike or bicycle, a boat, heavy electronic or construction equipment, and/or the like. The load may be connected/attached to or placed on any vehicle portion. For example, the load may be positioned on a vehicle top portion, a vehicle rear portion (e.g., vehicle tailgate), a vehicle bed, or a combination thereof.

To optimize vehicle performance, the system may first obtain user inputs indicative of a load type that may be connected/attached to or placed on the vehicle. The user inputs may further indicate the load size/dimensions associated with the load, the position of the load on the vehicle, and/or the like. For instance, the user inputs may indicate whether the load is positioned at the vehicle top portion and/or the vehicle rear portion.

The system may obtain the user inputs described above in different ways. In a first example scenario, the system may enable a user to use the drag-and-drop feature of a user interface to provide the user inputs. For instance, the user may drag-and-drop a bike image on a top portion of a vehicle image (indicating the vehicle's top portion) or a rear portion of the vehicle image (indicating the vehicle's rear portion) to create a visualization of the load position on the vehicle, via an interface associated with a user device or a vehicle Human-Machine Interface (HMI). In a second example scenario, the system may enable the user to sketch the vehicle and the load on the interface. In this case, the sketch may act as user inputs to the system. The user may use conventional drawing tools to sketch the vehicle and the load. In further aspects, the user may use Augmented Reality (AR) based sketching or holograph based sketching to prepare the sketch. In further aspects, the system may obtain a voice command or a user gesture from the user and prepare the sketch based on the voice command or the user gesture.

In a third example scenario, the system may render a plurality of pre-stored images on the user interface. Each pre-stored image may indicate the vehicle connected to a different type of load and position of the load relative to the vehicle. The user may select one image from the plurality of pre-stored images rendered on the interface, to provide the user inputs to the system. In a fourth example scenario, the system may obtain the user inputs from a detection unit (e.g., a camera) associated with the user device.

Based on the obtained user inputs, the system may estimate an aerodynamic profile of the vehicle with the load. The system may estimate the aerodynamic profile based on the load size/dimensions, the load position on the vehicle, and/or the like. In some aspects, the system may additionally obtain inputs from a vehicle sensor unit, which may include a lidar sensor, a radar sensor, and one or more vehicle cameras (e.g., a rear camera, a tailgate camera, a bed camera, and/or other cameras). The system may correlate the user inputs and the inputs obtained from the vehicle sensor unit to estimate the aerodynamic profile for the vehicle with the load. In such cases, the inputs from the vehicle sensor unit may augment the user inputs and enable the system to correctly estimate the vehicle's aerodynamic profile.

Responsive to estimating the vehicle's aerodynamic profile, the system may calculate an estimated range for the vehicle based on the aerodynamic profile, and perform a predetermined action responsive to calculating the estimated range to optimize vehicle operation/performance. In some aspects, the system may calculate the estimated range based on the aerodynamic profile along with a current battery (or fuel) level in the vehicle. In further aspects, the system may use additional factors/parameters to calculate the estimated range. For example, to calculate the estimated range, the system may use road grade information, weather information associated with a vehicle route, a vehicle type moving ahead of the vehicle, a following distance between the vehicle and another vehicle moving ahead of the vehicle, and/or the like.

The predetermined action described above may include modification of a route plan to optimize the vehicle performance, display of the estimated range on an interface for the user's reference, and/or the like. For instance, the system may leverage downhill movement to increase or optimize the travel energy efficiency associated with the vehicle (e.g., when the battery charge is at a state when adding energy is most beneficial). The system may further optimize the charging stops to minimize the journey duration or the journey resources. The system may additionally modify the vehicle speed based on the estimated range (e.g., to reduce the aerodynamic loads and maximize the effective vehicle range).

The present disclosure discloses a system that optimizes vehicle performance based on aerodynamics loading. The system facilitates optimal vehicle operation and movement when the vehicle may be carrying an external load. The system may increase the vehicle range when the vehicle may be carrying the load, based on load characteristics and load position on the vehicle.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

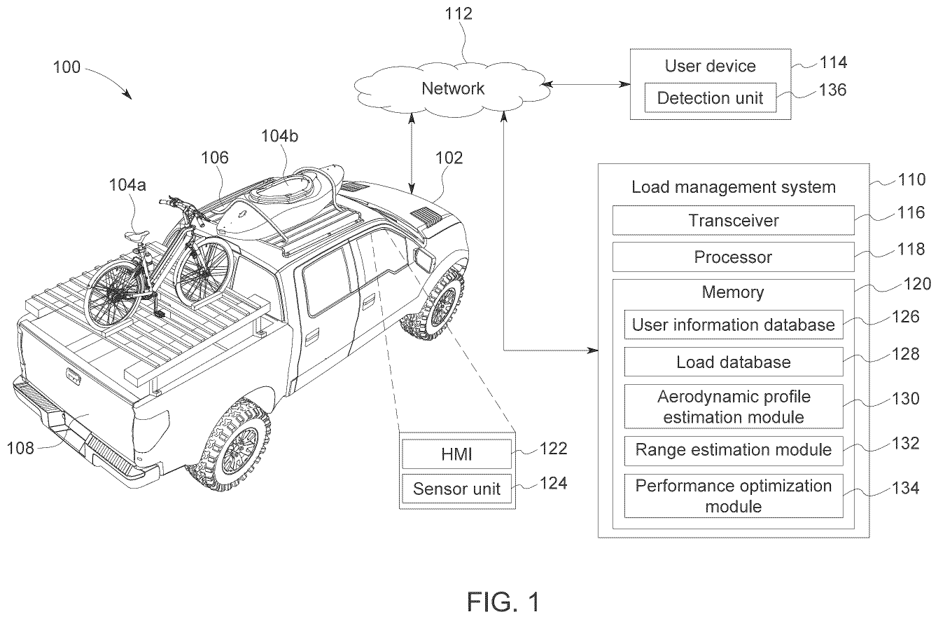

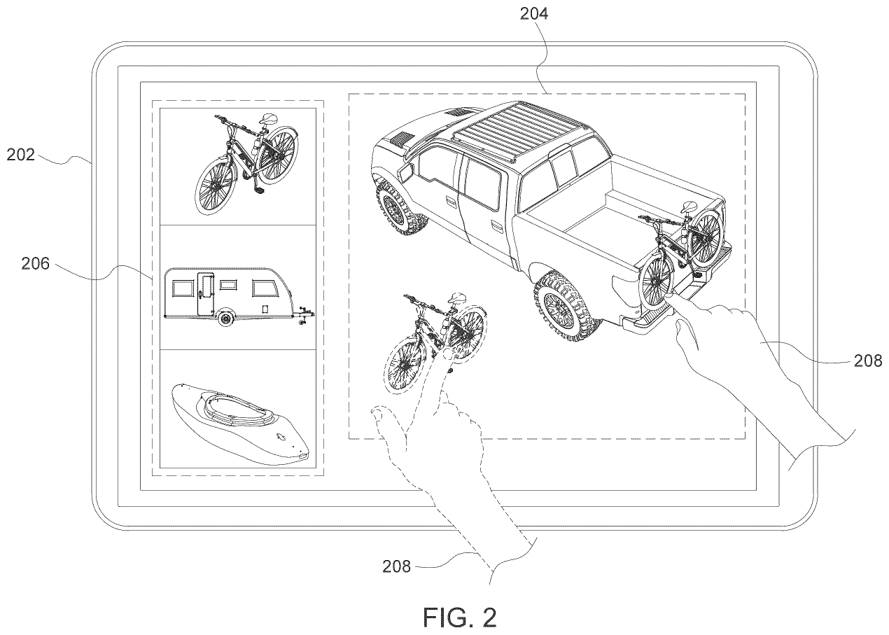

FIG. 1 depicts an example environment 100 in which techniques and structures for providing the systems and methods disclosed herein may be implemented. FIG. 1 will be described in conjunction with FIGS. 2-5.

The environment 100 may have include a vehicle 102. The vehicle 102 may take the form of any passenger or commercial vehicle, for example, a car, a work vehicle, a crossover vehicle, a truck, a van, a minivan, a taxi, a bus, etc. The vehicle 102 may be a manually driven vehicle and/or may be configured to operate in a partially or fully autonomous mode. Further, the vehicle 102 may include any powertrain such as a gasoline engine, one or more electrically-actuated motor(s), a hybrid system, etc.

The vehicle 102 may carry/haul one or more external loads 104a, 104b (collectively referred as load 104), which may be positioned/placed on an exterior portion of the vehicle 102. The load 104 may be, for example, a trailer, a bike or bicycle, a boat, heavy electronic or construction equipment, and/or the like. The load 104 may be connected/attached to or placed on any vehicle portion. For example, the load 104 may be positioned on a vehicle top portion 106, a vehicle rear portion 108, or a combination thereof. For instance, a bike may be positioned at the vehicle top portion 106 or positioned on a vehicle bed, or attached to a vehicle tailgate, or positioned on an open trailer connected to the vehicle rear portion 108, via a bike rack.

The environment 100 may further include a load management system 110 (or system 110) that may be hosted on a server or a distributed computing system, or may be a part of the vehicle 102. In a scenario when the system 110 is hosted on the server, the system 110 may be communicatively coupled with the vehicle 102 via one or more networks 112. The system 110 may additionally be connected to a user device 114 associated with a vehicle user, via the network(s) 112. The user device 114 may be, for example, a mobile phone, a laptop, a tablet, a smartwatch, or any other device having communication capability.

The network(s) 112, as described here, may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The system 110 may facilitate in optimal vehicle operation and movement, e.g., when the vehicle 102 may be carrying an external load (e.g., the load 104). To enable this operation, the system 110 may first obtain user inputs indicative of a type of the load 104 that is connected/attached to or placed on the vehicle 102. The user inputs may further indicate the load size/dimensions associated with the load 104, the position of the load 104 on the vehicle 102, and/or the like. For instance, the user inputs may indicate whether the load 104 is positioned at the vehicle top portion 106 and/or the vehicle rear portion 108.

Based on the obtained user inputs, the system 110 may estimate an aerodynamic profile associated with the vehicle 102 (with the load 104). It may be appreciated if the load 104 is attached to or placed on the vehicle 102, the vehicle's aerodynamic profile may get altered, in comparison to the vehicle's aerodynamic profile when the vehicle 102 is not carrying any external load. The system 110 is specifically configured to estimate this “updated” aerodynamic profile associated with the vehicle 102 when the vehicle 102 may be carrying the load 104, based on the user inputs.

Responsive to estimating the vehicle's aerodynamic profile, the system 110 may calculate an estimated range or a change in the driving efficiency for the vehicle 102 based on the aerodynamic profile, and perform a predetermined action responsive to calculating the estimated range or the change in the vehicle's driving efficiency. For instance, the system 110 may modify a route plan to optimize the vehicle performance, display the estimated range or the change in the vehicle's driving efficiency on an interface for the user's reference, and/or the like. In this manner, the system 110 facilitates optimal vehicle operation and movement when the vehicle 102 may be carrying the load 104. Details of the system 110 and its functioning is described below.

In some aspects, the system 110 may include a plurality of components including, but not limited to, a transceiver 116, a processor 118 and a memory 120. The transceiver 116 may receive/transmit data/information/signals from/to external systems and devices via the network(s) 112. For example, the transceiver 116 may receive the user inputs from the user device 114. The transceiver 116 may further receive/transmit data/information/signals from/to the vehicle 102. For example, the transceiver 116 may receive the user inputs from a vehicle Human-Machine Interface (HMI) 122. In addition, the transceiver 116 may receive inputs from a sensor unit 124 located in the vehicle 102. The sensor unit 124 may include one or more vehicle sensors including, but not limited to, a radio detection and ranging (radar) sensor configured for detection and localization of objects inside and outside the vehicle 102 using radio waves, a light detecting and ranging (lidar) sensor, vehicle interior and exterior cameras, and/or the like.

The processor 118 may be disposed in communication with one or more memory devices disposed in communication with the respective computing systems (e.g., the memory 120 and/or one or more external databases not shown in FIG. 1). The processor 118 may utilize the memory 120 to store programs in code and/or to store data for performing aspects in accordance with the disclosure. The memory 120 may be a non-transitory computer-readable storage medium or memory storing program codes that may enable the processor 118 to perform operations as per the present disclosure. The memory 120 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the memory 120 may include a plurality of databases and modules including, but not limited to, a user information database 126, a load database 128, an aerodynamic profile estimation module 130, a range estimation module 132 and a performance optimization module 134. These modules may be stored as computer executable instructions in the memory 120, which may be executed by the processor 118 to perform one or more operations as described in the present disclosure. The user information database 126 may store the user inputs provided by the user. The load database 128 may store images (or “first pre-stored images”) associated with different types of loads and images (or “second pre-stored images”) of positioning of different types of loads on different positions/portions of the vehicle 102.

In operation, the transceiver 116 may obtain the user inputs from the vehicle user, via an interface 202 (shown in FIG. 2) associated with the user device 114 or the vehicle HMI 122. As described above, the user inputs may be indicative of load type and the load size/dimensions associated with the load 104. The user inputs may further indicate a load position on the vehicle 102. The transceiver 116 may receive the user inputs via different mechanisms, described below in conjunction with FIGS. 2-5.

In a first example scenario, to obtain the user inputs, the processor 118 may render the interface 202 on the user device 114 or the vehicle HMI 122. The interface 202 may include a vehicle image (that may be stored in the memory 120) associated with the vehicle 102 in a first interface portion 204 (as shown in FIG. 2) of the interface 202, and a plurality of load images associated with different loads (e.g., bike, trailer, boat, etc.) in a second interface portion 206 of the interface 202. For instance, the processor 118 may render the vehicle image on an interface center portion and render the plurality of load images on an interface side portion (e.g., as a side bar) or an interface bottom portion (e.g., as a bottom bar). In some aspects, the processor 118 may fetch the plurality of load images and the vehicle image from the memory 120 before displaying them on the interface 202 as depicted in FIG. 2 and described above. In an exemplary aspect, the processor 118 may fetch the plurality of load images from the load database 128.

Responsive to rendering the interface 202 as described above, the processor 118 may enable the user (e.g., a user 208, shown in FIG. 2) to drag and drop a first image, of the plurality of load images, onto the vehicle image to provide the user inputs. For instance, the user 208 may drag and drop a bike image on the top portion of the vehicle image (indicating the vehicle top portion 106) or the rear portion of the vehicle image (indicating the vehicle rear portion 108, a vehicle tailgate or a vehicle bed) to create visualization of the load 104 on the vehicle 102. In this manner, the user 208 may indicate which load type is attached to the vehicle 102 and the position of the load 104 on the vehicle 102. The selected load image may also be indicative of load size and dimensions associated with the load 104 attached to or placed on the vehicle 102.

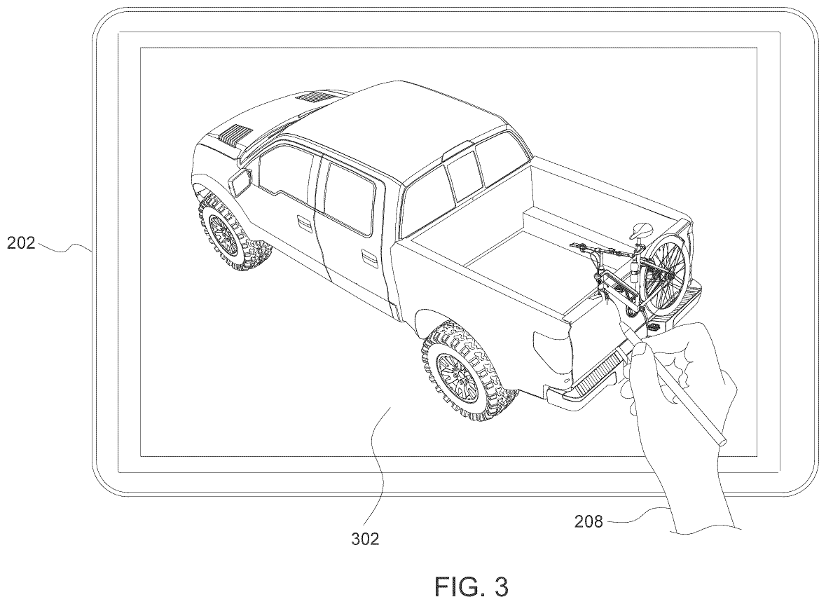

In a second example scenario, responsive to rendering the interface 202, the processor 118 may enable the user 208 to sketch 302 the vehicle 102 and the load 104 (as shown in FIG. 3) on the interface 202. The sketch 302 may indicate the load type that may be attached to the vehicle 102 and the load position on the vehicle 102. The sketch 302 may also be indicative of load size and dimensions. The user 208 may use a finger or a stylus to draw directly on the screen/interface 202. The user 208 may use conventional drawing tools to sketch the vehicle 102 and the load 104. In some aspects, the processor 118 may utilize AI assisted tools to assist the user 208 in preparing the sketch 302. In this case, the processor 118 may receive initial inputs (basic outline of the vehicle 102/load 104) from the user 208 and then prepare the final sketch based on the initial inputs.

In further aspects, the user 208 may use Augmented Reality (AR) based sketching or holograph based sketching to prepare the sketch 302. For example, the user 208 may sketch shapes in the air by using hand movements to provide the user inputs. In other aspects, the processor 118 may receive voice commands (or gesture-based inputs, written inputs) from the user 208 and may sketch the vehicle 102 with the load 104 image based on the voice commands. For example, the user 208 may provide a voice command “sketch a pickup truck and attach a bike to a vehicle tailgate” or “I have a rack with 2 mountain bikes on the vehicle top portion and 2 more road Bikes in a trailer hitch mounted rack on the back of my vehicle” to prepare the sketch 302 of the vehicle 102 and the load 104.

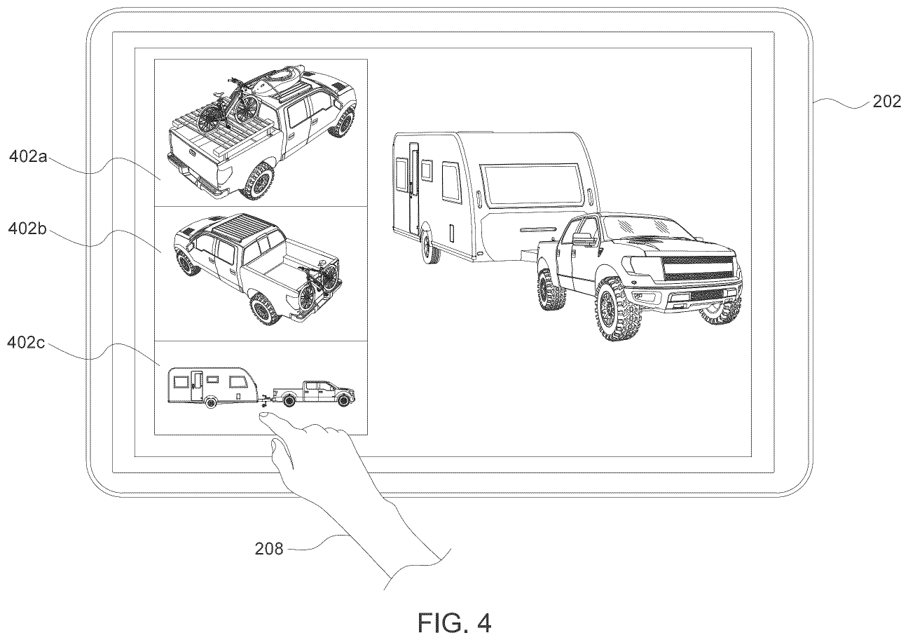

In a third example scenario, to obtain the user inputs, the processor 118 may render the interface 202, which may include a plurality of pre-stored images 402a, 402b, 402c (collectively referred to as pre-stored images 402, as shown in FIG. 4). The processor 118 may obtain or fetch the pre-stored images 402 from the memory 120 (e.g., from the load database 128) and display them on the interface 202, to obtain the user inputs. Each pre-stored image 402 may indicate the vehicle 102 connected to a different type of load and position of the load relative to the vehicle 102. Stated another way, each pre-stored image 402 may be indicative of a connection of the load 104 and the vehicle 102. In an exemplary aspect, the pre-stored images 402 may indicate, for example, the vehicle 102 with a trailer connected at the vehicle rear portion 108, the vehicle 102 with a bike positioned at the vehicle top portion 106 (or a vehicle bed) via a first bike rack, the vehicle 102 with a bike positioned at a vehicle tailgate via a second bike rack, the vehicle 102 with a boat at the vehicle top portion 106, and/or the like.

Responsive to rendering the interface 202 as described above, the processor 118 may obtain a user selection of a first image (e.g., the image 402a), from the pre-stored images 402. The selected first image may act as the user input, which may be indicative of load type and the load size/dimensions associated with the load 104. The selected first image may further indicate the load position on the vehicle 102. For example, the user 208 may select the image of a trailer attached to the vehicle 102 to indicate that the vehicle 102 may be connected to a trailer at the vehicle rear portion 108.

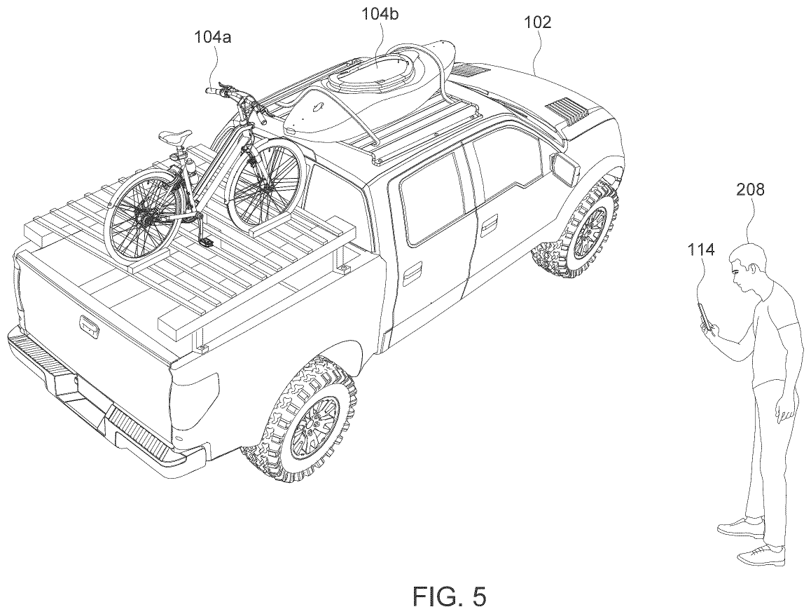

In a fourth example scenario, the processor 118 may obtain the user inputs from a detection unit 136 associated with the user device 114, as shown in FIG. 5. The detection unit 136 may be a camera associated with the user device 114, which may capture an image of the vehicle 102 and the load 104. The user 208 may use the user device 114 to capture the image of the vehicle 102 with the load 104 attached to it. The user 208 may capture (via the detection unit 136) multiple images including, but not limited to, a vehicle side view image with the load 104, a vehicle top view image with the load 104, a vehicle rear view image with the load 104, a vehicle front view image with the load 104, and/or the like. The user 208 may additionally or alternatively move around the vehicle 102 and capture (via the detection unit 136) a video recording of the vehicle 102 and the load 104, which may act as the user input.

Responsive to obtaining the user inputs by any of the mechanisms described above, the processor 118 may store the user inputs in the user information database 126. The processor 118 may further estimate an aerodynamic profile for the vehicle 102 when the load 104 is connected to the vehicle 102 based on the user inputs, by executing the instructions stored in the aerodynamic profile estimation module 130. It may be appreciated that the aerodynamic profile reflects how air interacts with the vehicle's shape (including the load 104) or how well a vehicle moves through the air. The aerodynamic profile influences a drag force (a force that opposes the vehicle motion, arising from the air resistance and the interaction of the vehicle's shape and surface (including the load) with the air) that the vehicle 102 may experience while traveling on the road. In some aspects, the processor 118 may determine aerodynamic load or the drag force associated with what the vehicle 102 is towing or hauling, e.g., based on the load size/dimensions, load position in the vehicle 102, vehicle size/dimension, etc. (which may all be part of the user inputs, as described above). The processor 118 may identify when the aerodynamic load had changed substantially due to the load 104, based on the user inputs, and accordingly estimate an “updated” aerodynamic profile associated with the vehicle 102 when the load 104 is connected to the vehicle 102.

In some aspects, the processor 118 may use the dimensions/sizes of the vehicle 102 and the load 104 (including the load position relative to the vehicle 102) to estimate the aerodynamic profile for the vehicle 102 with the load 104. The processor 118 may consider the load 104 (along with the vehicle 102) to estimate the vehicle's aerodynamic profile. In some aspects, the processor 118 may determine the load size/dimensions connected to the vehicle 102 based on the user inputs (and/or the inputs obtained from the sensor unit 124, as described below), and may estimate the vehicle's aerodynamic profile based on the load's size/dimensions. In some aspects, the processor 118 may utilize empirical models or theoretical models on the composite virtual image of the vehicle 102 and the load 104 to determine the load size/dimensions.

Similarly, the processor 118 may determine the load position relative to the vehicle 102 based on the user inputs, and estimate the vehicle's aerodynamic profile based on the load position on the vehicle 102. For example, the processor 118 may determine which load type is positioned at which vehicle portion (e.g., whether the load 104 is positioned on the vehicle top portion 106 (e.g., using slip controls algorithms which are used to determine if the vehicle 102 has load on the vehicle top portion 106), or in pickup boxes, or attached to the vehicle rear portion 108), and estimate the vehicle's aerodynamic profile based on such determination. In further aspects, the processor 118 may determine load characteristics (e.g., based on the user inputs and/or based on inputs from the sensor unit 124) and estimate the aerodynamic profile based on the load characteristics. For example, bicycle/bike wheels with spokes versus ice chest will have different drag when mounted to the vehicle rear portion 108. Such considerations may be factored-on by the processor 118 while estimating the vehicle's aerodynamic profile with the load 104. Similarly, when an open trailer is attached to the vehicle rear portion 108 and a boat is placed in the open trailer, the processor 118 may consider both the trailer and the boat (as a part of the load 104) to estimate the vehicle's aerodynamic profile. In a similar manner, the processor 118 may consider additional ladders, awnings on the truck/trailer side, V-nose or flat trailer fronts (as the flat face may have significantly more aero drag coefficient), vehicle top mounted ac/venting hoods, etc. to estimate the vehicle's aerodynamic profile. In further aspects, the processor 118 may consider a change in the vehicle height due to the load 104 to estimate the vehicle's aerodynamic profile.

In some aspects, the processor 118 may additionally obtain inputs from the sensor unit 124 associated with the vehicle 102, which may include the lidar sensor, the radar sensor, and the vehicle cameras (e.g., a rear camera, a tailgate camera, a bed camera, and/or other cameras). The processor 118 may correlate the user inputs and the inputs obtained from the sensor unit 124 to estimate the aerodynamic profile for the vehicle 102 with the load 104. In such cases, the inputs from the sensor unit 124 may augment the user inputs and enable the processor 118 to correctly estimate the vehicle's aerodynamic profile. Alternatively, the processor 118 may obtain inputs from the sensor unit 124, and estimate the vehicle's aerodynamic profile based on the inputs obtained from the sensor unit 124 only. In some aspects, the sensor unit 124 may determine the vehicle's aerodynamic profile (including the load profile) when the load 104 is within the field of view (FOV) of the sensor unit 124. For instance, the rear camera may capture the images of the trailer and the loads positioned on the vehicle bed. The processor 118 may obtain such images from the rear camera and determine the vehicle's aerodynamic profile based on the obtained images.

In additional aspects, to estimate the vehicle's aerodynamic profile, the processor 118 may estimate a drag coefficient for the vehicle 102 with the load 104 based on the user inputs, and estimate the vehicle's aerodynamic profile based on the drag coefficient. It may be appreciated that the drag coefficient is indicative of how aerodynamically streamlined a vehicle is as it moves through the air. The drag coefficient reflects how much air resistance the vehicle encounters. As an example the lower the drag coefficient, the less drag, and the better the aerodynamic efficiency. In some aspects, the processor 118 may utilize Machine Learning (ML) models to estimate the drag coefficient. For example, training data of vehicle with different loads that may be positioned at different locations on the vehicle may be used to train a model to predict drag coefficient(s) based on the user inputs. The processor 118 may correlate the drag coefficient and other factors such as vehicle velocity to estimate the aerodynamic profile for the vehicle 102 with the load 104.

In some aspects, the processor 118 may determine/estimate a change in the frontal area/drag coefficient of the combined vehicle (e.g., the vehicle 102 and the load 104) by using the user inputs to estimate how the frontal area has increased/decreased in size and changed the vehicle shape. The new frontal area can be measured in proportion to the vehicle size or based on the additional object/load size. The modification to the shape/object that was added can be compared to the historical data from a wind tunnel/CFD to estimate how the coefficient of drag has changed based on the placement of the object/load 104 and the object/load type.

Responsive to estimating the vehicle's aerodynamic profile, the processor 118 may calculate an estimated range or a change in the driving efficiency for the vehicle 102 based on the aerodynamic profile, by executing the instructions stored in the range estimation module 132. Stated another way, the processor 118 estimates change in the vehicle load (or aerodynamic load) due to the load 104 and then calculate the vehicle's estimated range based on the changed vehicle load. The processor 118 may calculate the estimated range based on the aerodynamic profile along with a current battery (or fuel) level in the vehicle 102. In some aspects, the processor 118 may consider the drag force to calculate the estimated range. The estimated range may indicate how far the vehicle 102 may move with the current load and the current battery (or fuel) level for the vehicle 102. The processor 118 may determine the “delta” (or a difference) in the aerodynamic force from the previous vehicle configuration to the new configuration and determine how much that would affect the vehicle range at various vehicle speeds (feedforward term).

In further aspects, the processor 118 may use additional factors/parameters to calculate the estimated range or the change in the vehicle's driving efficiency. For example, the processor 118 may use road grade information to calculate the estimated range. In further aspects, to calculate the estimated range, the processor 118 may obtain (from an external server (not shown)) weather information associated with a vehicle route on which the vehicle 102 may be traveling. Responsive to obtaining the weather information, the processor 118 may estimate the wind direction and/or the wind speed in the vehicle route based on the weather information. Based on the wind direction and/or the wind speed, the processor 118 may calculate the estimated range. In some aspects, the processor 118 may utilize ML models to estimate the wind direction and/or the wind speed. The processor 118 may also adjust the ML models based on the weather data/information for wind direction, and/or determine the actual wind direction when the vehicle 102 comes to a stop (e.g., by using the inputs obtained from the sensor unit 124/a vehicle sensor).

In some aspects, the processor 118 may dynamically calculate the estimated range for the vehicle 102 during the vehicle trip. Further, the processor 118 may dynamically determine a vehicle type of a second vehicle (not shown) that may be moving in proximity to a vehicle front portion (in real time), and calculate the estimated range for the vehicle 102 based on the second vehicle type. For example, the processor 118 may dynamically determine whether the vehicle 102 is moving behind a large truck or a motor cycle, as the aerodynamic drag may be less when the vehicle 102 may be moving behind a large truck. In further aspects, the processor 118 may determine a probability of the types of vehicles that might move in proximity to vehicle front portion based on the vehicle's route information, and then accordingly calculate an estimated range. For example, the processor 118 may determine that the probability of large trucks moving in proximity to vehicle front portion (associated with the vehicle 102) may be high when the vehicle 102 travels between a location “A” and a location “B” (in which mostly trucks operate). The processor 118 may calculate the estimated range based on such probability determination. In some aspects, the processor 118 may utilize ML models to dynamically calculate the estimated range during the vehicle trip.

In addition, the processor 118 may dynamically determine a following distance (a distance between the vehicle 102 and another vehicle moving in the vehicle's front portion, including cruise control following distance) between the vehicle 102 and the second vehicle moving in proximity to the vehicle front portion associated with the vehicle 102 (in real time), and calculate the estimated range for the vehicle 102 based on the following distance. In addition, when the load 104 may be a trailer that may be connected at the vehicle rear portion 108, the processor 118 may determine a gap or distance between the vehicle 102 and the trailer, and estimate the range for the vehicle 102 based on the gap (as the aerodynamic profile associated with the vehicle 102 and the load 104 may change based on the gap). In this case, the processor 118 may estimate an aero turbulence between the vehicle 102 and load 104 based on the gap, and estimate the range for the vehicle 102 based on the estimated aero turbulence. In some aspects, the processor 118 may consider load weight as well to calculate the estimated range. In further aspects, the processor 118 may consider a change in the vehicle height due to the load 104 to determine the vehicle's aerodynamic profile and the estimated range.

In further aspects, the processor 118 may determine an expected route and an expected vehicle speed on the route based on the vehicle route information, and may estimate the range based on the expected route and/or the expected vehicle speed. In some aspects, range for electric vehicles and ICE vehicles is calculated by estimating an energy/fuel consumption using short term and long term energy consumption estimates (for all electric operation including DCDC loads, climate loads, loads associated with trailer tow mode, vehicle speeds, etc.) and the remaining usable battery energy from the HV battery/fuel in the fuel tank. The range estimate is adaptive and empirical so over time, the change in aerodynamic load would be factored-in to the range estimate. The processor 118 may provide a “feedforward” adjustment to range that would “decay”/decrease over time. The processor 118 may consider mass approximation (throttle input vs speed or torque output) as a way to detect headwinds or increased aero frontal loads. The processor 118 may increment/decrement the range with the range feedforward term and have the term decay over time based on how fast the distance to empty (range algorithm) is learning the current vehicle energy consumption (differences in calibration/HV battery SOC result in different learning rates).

Responsive to calculating the estimated range, the processor 118 may perform a predetermined action to optimize the vehicle performance and the energy usage, by executing instructions stored in the performance optimization module 134. In some aspects, the predetermined action may include displaying the estimated range on the interface 202. In further aspects, the predetermined action may include modifying a route plan for the vehicle 102. For instance, the processor 118 may leverage downhill movement to increase or optimize the travel energy efficiency associated with the vehicle 102 (e.g., when the battery charge is at a state when adding energy is most beneficial). The processor 118 may further optimize the charging stops to minimize the journey duration or the journey resources. In further aspects, the predetermined action may include modifying the vehicle speed (e.g., to reduce the aerodynamic loads and maximize the effective vehicle range).

In further aspects, the processor 118 may enable fleet managers to remotely do the configuration/selection process based on images provided by the vehicle users and communicate back to the vehicle for real time effects on the vehicle fleet planning/routing/decision making process. Based on the inputs from the fleet manager, the processor 118 may adjust routes/stops/charging stops and vehicle timing/customer delivery and job site related expectations in real time.

In further aspects, when the modeled road load vs. the actual road load is different by a significant factor, tire pressure monitors will be checked for proper tire pressure and user may be advised via the interface 202 to check tire pressure for towed elements such as trailers to verify that improper tire pressure is not resulting in increased road load.

The vehicle 102 implements and/or performs operations, as described here in the present disclosure, in accordance with the owner manual and safety guidelines. In addition, any action taken by the user 208 based on the notifications provided by the vehicle 102 should comply with all the rules specific to the location and operation of the vehicle 102 (e.g., Federal, state, country, city, etc.). The notifications, as provided by the vehicle 102, should be treated as suggestions and only followed according to any rules specific to the location and operation of the vehicle 102.

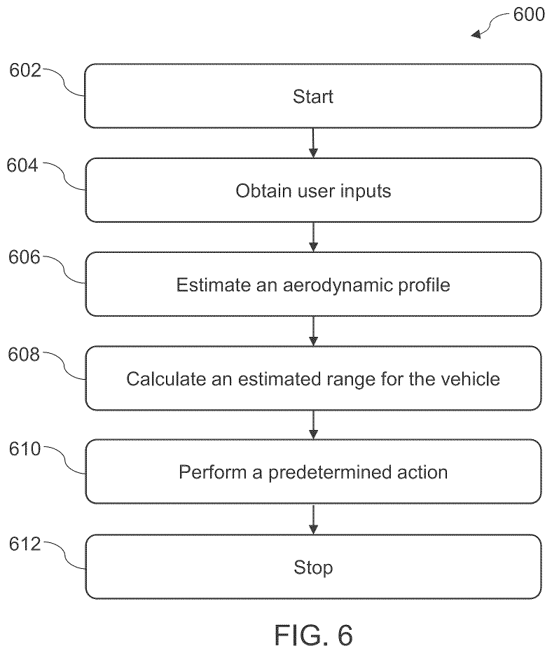

FIG. 6 depicts a flow diagram of an example method 600 to optimize vehicle movement in accordance with the present disclosure. FIG. 6 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 600 starts at step 602. At step 604, the method 600 may include obtaining, by the processor 118, the user inputs indicative of load type connected to the vehicle 102. At step 606, the method 600 may include estimating, by the processor 118, the aerodynamic profile for the vehicle 102 with the load 104 based on the user inputs.

At step 608, the method 600 may include calculating, by the processor 118, the estimated range for the vehicle 102 based on the aerodynamic profile. At step 610, the method 600 may include performing, by the processor 118, the predetermined action responsive to calculating the estimated range. The examples of the predetermined action are described above in conjunction with FIG. 2.

At step 612, the method 600 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a processor; and
a memory for storing instructions, the processor executing the instructions to:
obtain user inputs indicative of a type of a load connected to a vehicle;
estimate an aerodynamic profile of the vehicle with the load based on the user inputs;
calculate an estimated range or a change in a driving efficiency for the vehicle based on the aerodynamic profile; and
perform a predetermined action responsive to calculating the estimated range.

2. The system of claim 1, wherein the processor is configured to obtain the user inputs from an interface.

3. The system of claim 2, wherein the interface is associated with a user device communicatively coupled to the vehicle.

4. The system of claim 2, wherein the interface is associated with a vehicle Human-Machine Interface (HMI).

5. The system of claim 2, wherein the user inputs comprise a sketch of the vehicle and the load.

6. The system of claim 2, wherein to obtain the user inputs, the processor is configured to:
render a plurality of pre-stored images on the interface, wherein each image is indicative of a connection of the load and the vehicle; and
obtain a user selection of a first image, from the plurality of pre-stored images, wherein the first image acts as the user inputs.

7. The system of claim 2, wherein to obtain the user inputs, the processor is configured to:
render a vehicle image associated with the vehicle in a first interface portion of the interface, and a plurality of load images associated with a plurality of loads in a second interface portion of the interface; and
enable a user to drag and drop a first image, of the plurality of load images, onto the vehicle image to provide the user inputs.

8. The system of claim 1, wherein the processor is configured to obtain the user inputs from a detection unit of a user device, wherein the detection unit is configured to capture image of the vehicle and the load.

9. The system of claim 1, wherein the processor is configured to obtain the user inputs from a user voice command.

10. The system of claim 1, wherein the processor is further configured to:
determine dimensions of the load based on the user inputs; and
estimate the aerodynamic profile of the vehicle with the load based on the dimensions of the load.

11. The system of claim 1, wherein the processor is further configured to:
determine a position of the load relative to the vehicle based on the user inputs; and
estimate the aerodynamic profile of the vehicle with the load based on the position of the load.

12. The system of claim 1, wherein the processor is further configured to:
estimate a wind direction in a vehicle route based on weather information; and
calculate the estimated range or the change in the driving efficiency for the vehicle based on the wind direction.

13. The system of claim 1, wherein the processor is further configured to:
dynamically determine a vehicle type of a second vehicle moving in front of the vehicle; and
calculate the estimated range or the change in the driving efficiency for the vehicle based on the vehicle type of the second vehicle.

14. The system of claim 1, wherein the processor is further configured to:
dynamically determine a following distance between a third vehicle moving in front of the vehicle; and
calculate the estimated range or the change in the driving efficiency for the vehicle based on the following distance.

15. The system of claim 2, wherein to perform the predetermined action, the processor displays the estimated range or the change in the driving efficiency for the vehicle on the interface.

16. The system of claim 1, wherein to perform the predetermined action, the processor modifies a route plan for the vehicle.

17. The system of claim 1, wherein to perform the predetermined action, the processor modifies a vehicle speed.

18. The system of claim 1, wherein the processor is further configured to:
obtain inputs from a vehicle sensor; and
estimate the aerodynamic profile of the vehicle with the load based on the inputs obtained from the vehicle sensor.

19. A method comprising:
obtaining, by a processor, user inputs associated with a load connected to a vehicle;
estimating, by the processor, an aerodynamic profile of the vehicle with the load based on the user inputs;
calculating, by the processor, an estimated range or a change in a driving efficiency for the vehicle based on the aerodynamic profile; and
performing, by the processor, a predetermined action responsive to calculating the estimated range.

20. A non-transitory computer-readable storage medium having instructions stored thereupon which, when executed by a processor, cause the processor to:
obtain user inputs associated with a load connected to a vehicle;
estimate an aerodynamic profile of the vehicle with the load based on the user inputs;
calculate an estimated range or a change in a driving efficiency for the vehicle based on the aerodynamic profile; and
perform a predetermined action responsive to calculating the estimated range.
